(19) United States
(12) Patent Application Publication
(10) Pub. No.: US 2006/0254793 A1
(43) Pub. Date: Nov. 16, 2006

(54) Metallic conductor and process of manufacturing same

(76) Inventors: Luis Santos Lopez, Barcelona (ES); Gerardo Pallares Tuset, Barcelona (ES); Jose Pertegaz Moya, Barcelona (ES); Francisco Jose Martinez Bragado, Barcelona (ES)

Correspondence Address: LADAS & PARRY, 26 WEST 61ST STREET, NEW YORK, NY, 10023, US

(21) Appl. No.: 10/550,322

(22) PCT Filed: Mar. 8, 2004
(86) PCT No.: PCT/EP04/02512

§ 371 Date: Jul. 10, 2006

(30) Foreign Application Priority Data
Mar. 28, 2003 (EP) 03380076.4

(51) Int. Cl. H01B 11/06

(52) U.S. Cl. 174/36

(57) ABSTRACT

A metallic conductor (21) that comprises a collected assembly of wires (22) so that it assumes a predetermined polygonal cross-section such as a circular sector or similar. Consequently, starting from an assembly of metallic conductors (21) it is possible to obtain a flexible cable (23), of reduced dimensiones, smaller final diameter of the finished cable, and reduced weight per unit length that includes a plurality of insulated multi-wire conductors (21) where each multi-wire each multi-wire conductor (21) has a predetermined polygonal cross-section.

### OBJECT OF THE INVENTION

The present invention relates, in general, to a metallic conductor composed of a plurality of wires which adopts a predetermined polygonal cross-section.

More concretely, the present invention relates to a metallic conductor suitable for forming an electric and/or communication cable, which is composed of a collected assembly of wires that adopts a predetermined polygonal cross-section, such as a circular sector, in such a way that the predetermined form is maintained over time after the metallic conductor is submitted to an extrusion process.

### STATE OF THE ART

In general, a multicore cable suitable for carrying electric power is composed of insulated conductors surrounded by a covering for mechanical protection.

The multicore cable assumes a circular cylindrical external shape as a consequence of the polygonal distribution of the multi-wire conductors. For example, in the case when the cable is composed of three conductors, the centres of the latter assume a triangular arrangement inside a circular cylindrical external protective covering that surrounds the arrangement of conductors.

The said multicore cable is said to be flexible since each multi-wire conductor of which it is composed is in turn composed of a collected assembly of wires of copper, aluminium, tinned copper or other alloys with diameter less than or equal to 0.61 mm in accordance with the requirements of classes V and VI of standard IEC-60228. Obviously each multi-wire conductor is surrounded by a layer of insulating material such as PVC, polyethylene, crosslinked polyethylene, ethylene-propylene, thermoplastic rubbers and halogen-free materials.

It should be pointed out that the triangular arrangement of the multi-wire conductors gives rise to dead spaces that have to be occupied by material corresponding to the protective covering of the flexible cable, the diameter of which is determined by the arrangement of the multi-wire conductors.

Consequently, grouping of several conductors under a single covering leads to an increase of the cross-section of the flexible cable, of its weight and, therefore, of the cost of the said flexible cable, as a result of using a larger quantity of material in the protective covering.

Accordingly, it has become necessary to develop a flexible multi-wire metallic conductor that has a predetermined cross-section in such a way that the overall size of the flexible cable is reduced, and therefore the weight per unit length and the cost are reduced.

### CHARACTERIZATION OF THE INVENTION

One aim of the present invention is to provide a metallic conductor that comprises a collected assembly of wires so that it assumes a predetermined polygonal cross-section such as a circular sector or similar.

Another aim of the invention is to provide a flexible cable, of reduced dimensions, smaller final diameter of the finished cable, and reduced weight per unit length that includes a plurality of insulated multi-wire conductors, since each multi-wire conductor has a predetermined polygonal cross-section.

Another aim of the invention is to provide a cable for which there is reduced consumption of protective materials in its process of manufacture.

Another aim of the present invention is to permit the coiling of a larger number of linear metres of cable on spools employed for coiling cables that contain conductors of circular cross-section.

Another aim of the present invention is to provide a cable that handles easily, i.e. once the protective covering and the insulating covering that surrounds each conductor have been detached, an assembly of wires is obtained that can be easily modified and shaped.

### BRIEF DESCRIPTION OF THE DIAGRAMS

A more detailed explanation of the invention is given in the following description, based on the appended drawings in which:

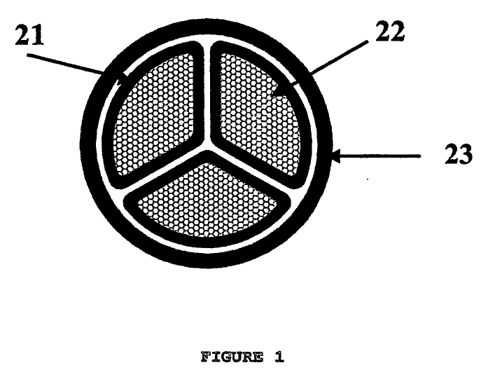

FIG. 1 shows a view of a cross-section of a cable according to the invention.

### DESCRIPTION OF THE INVENTION

FIG. 1 shows a cross-section of a cable 23 of insulated phases that comprises metallic conductors 21 which, in their turn, each include a collected assembly of wires 22, so that the conductor 21 has a predetermined polygonal cross-section, such as a circular sector.

Consequently, the polygonal cross-section comprises a combination of at least one straight side and one curved side.

It should be pointed out that each conductor 21 as well as the cable 23 that is formed by grouping several multi-wire conductors 21 under a common protective covering are flexible, since each wire has a diameter less than or equal to 0.61 nm.

Before being grouped under the common covering that forms cable 23, each conductor 21 was enveloped in a layer of an insulating thermoplastic or thermosetting polymeric material such as polyethylene, polyester, fluorinated polymer, polyolefin, polyamide, polyimide, polyurethane, polyvinyl chloride, thermoplastic elastomer, ethylene-propylene, polychloroprene or silicone rubber, as well as their compounds and derivatives which as well as providing electrical insulation makes it possible to maintain the predetermined cross-section that was imparted to it by a mechanical means of deformation.

That is, once it has been formed in a compressing means, each multi-wire conductor 21 is fed to a mechanical means of deformation with the aim that, at its outlet, a multi-wire conductor 21 is obtained with the desired cross-section and this will be fed to an extrusion means, so that at the outlet of the extrusion process the multi-wire conductor 21 is obtained with the desired cross-section.

Compressing has the objective of collecting together all the wires that will form the conductor 21 in a cable-making machine to obtain a circular shape.

It should be pointed out that the mechanical means is able to give conductor 21 the desired shape and ensure that this is maintained until conductor 21 is confined under the insulation until, in its case, the said insulating material is removed or, in some other way, the multi-wire conductor 21 is exposed. This means that the insulating material holds the wires in the form that they were given in the mechanical means of deformation.

Once the various insulated phases that will make up the cable 23 have been obtained, the said phases are cabled in cable-making machines of insulated conductors 21 to obtain a regular cabling of the conductors 21 of polygonal cross-section to obtain a cable 23 of final, overall circular cross-section. The said process is widely known in the state of the art.

For example, the extrusion process of conductor 21 is carried out using vacuum techniques that maintain the original shape of conductor 21 by replication of the insulation.

It should be pointed out that with other cabling techniques it is possible to group several conductors 21 in a cable with a rectangular cross-section, for example a flat cable. Accordingly, cable 23 can comprise conductors 21 of different polygonal cross-sections such as a rectangular section and a semicircular section.

On the other hand, the layer of protective material can comprise several layers with different or with similar physical characteristics, for example it can include a metallic protective material.

Although the invention has been described with reference to one embodiment thereof, numerous changes and modifications of the invention may be obvious to a person skilled in the art, without departing from its spirit and scope, and it is intended that all such changes and modifications are included within the scope of the following claims.

1. Metallic conductor for electric and/or communication cable that comprises a collected assembly of wires (22); characterized in that conductor (21) assumes a predetermined polygonal cross-section comprising one curved side.

2. Conductor according to claim 1, in which the polygonal cross-section comprising at least one straight side.

3. Conductor according to claim 2, in which the polygonal cross-section comprising a combination of at least one straight side and one curved side.

4. Conductor according to claim 3, in which the polygonal cross-section is a circular sector.

5. Conductor according to claim 1, in which the diameter of each wire (22) is less than or equal to 0.61 mm.

6. Conductor according to claim 1, in which the conductor (21) is surrounded by a layer of an insulating material.

7. Conductor according to claim 6, in which the layer of insulating material is thermoplastic and/or thermosetting, such as polyethylene, polyester, fluorinated polymer, polyolefin, polyamide, polyimide, polyurethane, polyvinyl chloride, thermoplastic elastomer, ethylene-propylene, polychloroprene or silicone rubber, as well as their compounds and derivatives.

8. Electric and/or communication cable that comprises a plurality of conductors (21) according to claim 1, electrically insulated from one another, and in their turn grouped together by a cabling process under a covering or a common binding element, characterized in that the conductors (21) assume a predetermined polygonal arrangement comprising a curved side.

9. Cable according to claim 8, in which the predetermined polygonal arrangement includes at least one straight side.

10. Cable according to claim 9, in which the predetermined polygonal arrangement includes a combination of at least one straight side and one curved side.

11. Cable according to claim 8, in which the predetermined polygonal arrangement is a circle.

12. Cable according to claim 8, in which the predetermined polygonal arrangement is a rectangle.

13. Cable according to claim 11, in which the cable (23) comprises conductors (21) of different polygonal cross-sections.

14. Cable according to claim 8, in which the predetermined polygonal arrangement is surrounded by at least one layer of a protective material.

15. Cable according to claim 14, in which the layer of protective material is a metallic protective material.

16. Cable according to claim 15, in which the layer of protective material is a thermoplastic and/or thermosetting polymeric protective material.

17. Cable according to claim 14, in which the layer of protective material is a textile material applied in the form of a protective belt.

18. Cable according to claim 15, in which the predetermined polygonal arrangement is surrounded by a combination of layers of protective material.

19. Method of manufacture of a metallic conductor (21) according to claim 1, characterized in that the method comprises at least the stages of:
deformation, using a mechanical means of deformation, of a metallic conductor (21) that comprises an assembly of round metallic wires (22) for achieving the predetermined polygonal cross-section, and
extrusion, using an extrusion means, of the metallic conductor (21) obtained in the preceding operation.

20. Cable according to claim 12, in which the cable (23) comprises conductors (21) of different polygonal cross-sections.
